(19) United States
(12) Patent Application Publication
(10) Pub. No.: US 2010/0032386 A1
(43) Pub. Date: Feb. 11, 2010

(54) Water purification with a peltier heat pump

(76) Inventor: Kurt Lehovec, Los Angeles, CA (US)

Correspondence Address: Eugene Oak, 610 S. Van Ness Ave, Los Angeles, CA, 90005, US

(21) Appl. No.: 12/228,030

(22) Filed: Aug. 8, 2008

(51) Int. Cl. B01D 35/00; F25B 21/02; F25B 27/00; F25B 21/00

(52) U.S. Cl. 210/774; 62/3.3; 62/235.1; 62/3.4

(57) ABSTRACT

An energy efficient distillation process in which the heat of evaporation is recovered as the heat of condensation and recycled by a Peltier heat pump to promote further evaporation.

### BACKGROUND OF THE INVENTION

Natural catastrophes such as the recent typhoon in Myanmar have left many thousands without drinking water for survival. Importing drinking water is overly cumbersome and distribution is often difficult for people with means of obtaining, nor access to portable water. Thus, there is an obvious need for a local portable device to produce pure portable drinking water from a contaminated source.

### SUMMARY OF THE INVENTION

Contaminated water is vaporized and condensed as pure water. This well-known distillation process requires the contaminated water temperature to be higher than that of the condensed liquid. The present invention generates this temperature difference by inserting a Peltier heat pump between the purified liquid and the contaminated source liquid. The power source for the heat pump is provided by a solar panel. The evaporation rate of the contaminated water is increased by a manually operated vacuum pump which evacuates the air from the duct between the contaminated source and the condensed purified water.

### BRIEF DESCRIPTION OF THE PREFERRED EMBODIMENT

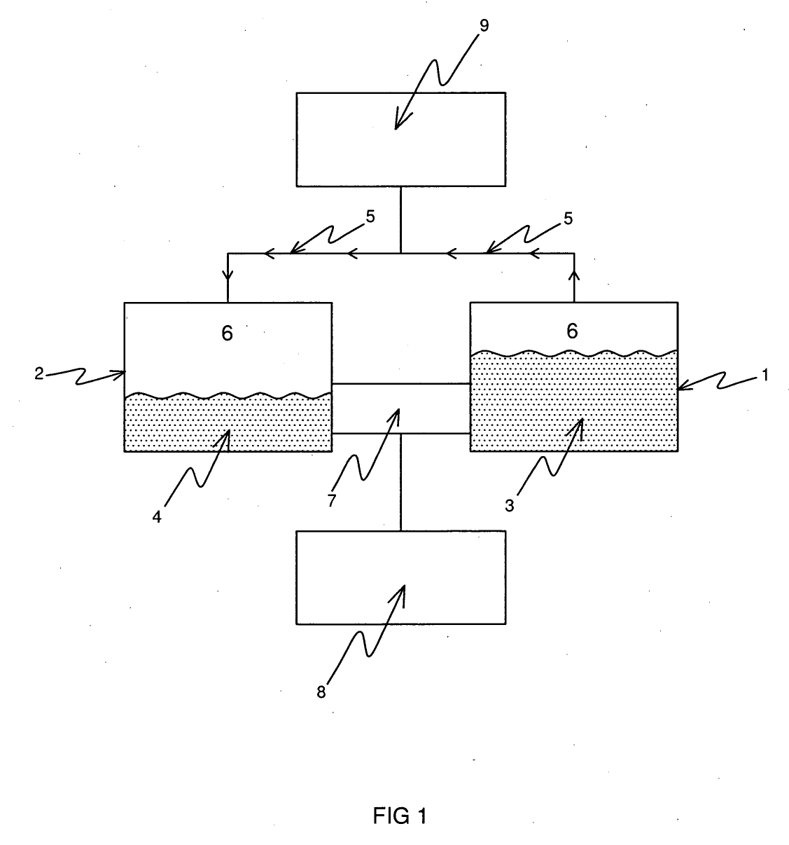

FIG. 1 is a block diagram of the lay-out of the essential components of this invention.

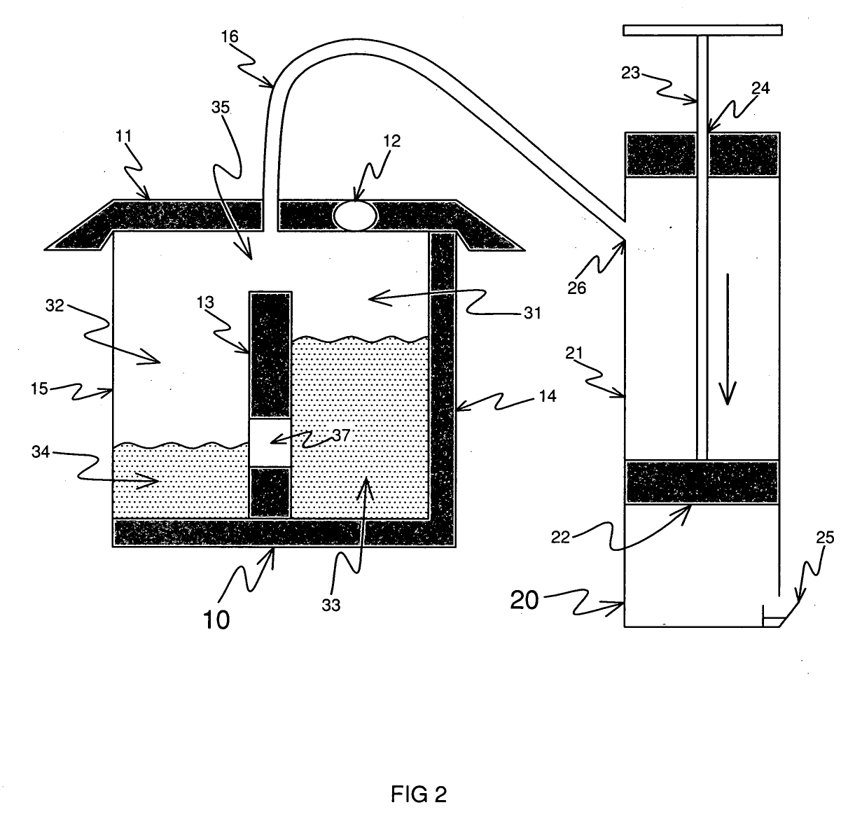

FIG. 2 is a vertical cross-section through a water purification apparatus of this invention.

### DETAILED DESCRIPTION OF THE PREFERRED EMBODIMENT

FIG. 1 is a block diagram of the essential components for the purification process of the present invention: Chambers (1) and (2) for the contaminated water source (3) and for the distilled purified water (4), respectively; an air duct (5) between these chambers for transport of water vapor (6) from the contaminated water (3) to the purified distilled water (4) as indicated by the arrows; a Peltier heat pump (7) inserted between these chambers (1) and (2) recycling the heat of condensation from (4) to supply the heat for evaporation to (3); a solar panel (8) to power the Peltier heat pump (7) and a manually operated vacuum pump (20) (FIG. 2) for initial reduction of the air pressure in the chambers (1) and (2) and in the duct (5).

FIG. 2 is a schematic vertical cross section of a distillation apparatus of this invention. The closed container (10) has a removable cover (11) with an observation window (12) for monitoring the level of the contaminated water (3). The partial dividing wall (13) separates the container (10) into the two chambers (1) and (2) for the contaminated water (3) and the purified water (4), respectively.

The dividing wall (13) contains the Peltier pump (7) and leaves the air space (5) open for vapor transport from (3) to (4). The dividing wall (13) facilitates thermal isolation to prevent heat loss of the contaminated water. The same thermal isolation applies to the outside wall (14). However, thermal isolation does not apply to the outside wall (15). The heat transfer from the ambient into the distilled water, cooled by the Peltier pump (7), is the preferred embodiment of the present invention.

The air hose (16) connects the air duct (5) to the vacuum pump (20). The vacuumed pump (20) is similar in design to an inverted hand operated bicycle pump. While a hand operated bicycle pump pumps air from the ambient into a bicycle tire, the vacuum pump (20) pumps air from the container (10) into the ambient. The vacuum pump (20) includes but is not limited to a cylinder (21) with a piston (22) which is movable by the rod (23) through an opening (21) in the upper enclosure of the cylinder (21). As the piston is moved downwards the air captured by the piston is compressed. This opens the valve (25) to release the compressed air. When the piston is then moved upward, a vacuum is created under the piston which closes the valve (25). The air above the piston, which was sucked-in from the chamber by the downward motion of the piston, is temporarily pushed back into the chamber through the opening (26), but returns to the vacuum under the piston when the piston moves above (26). Then the process of evacuation starts again with the piston moving downwards. With each downwards/upwards stroke of the piston a volume of air equal to the volume of the cylinder is removed from the container into the ambient.

The purification process of the present invention proceeds as follows: starting with an empty container (10), the cover (11) of the container is removed and contaminated water (3) is poured into chamber (1). Subsequently the cover (11) is replaced and the vacuum pump (20) is activated to cause boiling of the contaminated water (3). Subsequently, the evacuation is stopped. The boiling generates sufficient humidity in the chamber (2) that condensation on the Peltier pump (7) occurs as the Peltier pump (7) is subsequently switched on. The heat of this condensation is transferred by the Peltier pump to the contaminated water (3), raising the temperature facilitating compensation for the heat loss caused by the evaporation after a steady state operation is established. This process establishes a steady state heat cycle without any need for an external power input; except for the energy operation of the Peltier pump itself.

The onset of evaporation and its rate can be accelerated by initial partial evacuation of the air in the duct (5) by the manual vacuum pump (20). The contaminated water boils when its vapor pressure exceeds the residual air pressure in the air duct (5).

The process can be observed through the observation window (12) in the cover (11). When enough purified water is collected, the Peltier pump is switched off, the cover (11) is removed and the purified water is poured out. The chamber (1) is refilled with contaminated water and the purification process is repeated.

The preferred embodiment of the present invention is the Peltier heat pump. The Peltier heat pump is a commercially available solid state device without moving parts. The Peltier heat pump is a module bordered by two contact plates for heat flow. Direct current passed through a Peltier module promoting the internal heat transfer P. This heat transfer of the Peltier heat pump cools one plate and heats the other plate. The resulting temperature difference causes an undesirable internal backflow of heat B by thermal conduction. Thus, the available heat transfer is delivered by the Peltier module from the hot plate to the contaminated liquid (3) is P−B. Since the backflow B increases with temperature difference between the plates, a Peltier module can generate either a higher available heat transfer rate at a lower temperature difference; or, can generate a lower available heat transfer rate at a higher temperature difference, depending on the heat dissipation from the contaminated water source (3).

Performance data for Peltier modules, provided by the manufacturer, include graphs of the temperature difference between the plates, versus the available heat flow P−B at various currents.

The graph for the ITI series 100-B of the INTERNATIONAL THERMAL INSTRUMENT COMPANY indicates a temperature difference of 28° C. at an available heat transfer of 4 watts for a current of 4 amps. This current requires a voltage of 6 volts applied to the module. With the distilled water at a room temperature of 20° C., the hot plate temperature is 48° C.

The cited hot plate temperature is not sufficient for a water evaporation rate equivalent to 4 watts at one atmospheric pressure. To facilitate a higher evaporation rate, two or more Peltier modules need be used in series. Alternatively, creating a lower atmospheric pressure will facilitate boiling of contaminated water at a lower temperature.

Boiling occurs when the water vapor pressure exceeds the ambient air pressure. As an example, boiling occurs at 52° C. if the air pressure is reduced to 100 Torr. The reduction in air pressure to 100 Torr can be accomplished by a hand operated bicycle pump (20) in about 20 strokes if the pump cylindrical volume equals 10% of the volume of air to be evacuated.

Having thus achieved a steady state distillation, the available heat transfer rate of 4 watts by the Peltier module equals the energy rate needed for evaporation of the contaminated water. Thus the corresponding purified water generation rates are as follows:

Evaporation of one mole (18 grams) of water requires 10.27 Kcal of energy. The available heat transfer rate of 4 watts provides 1.7 g of purified water per second; which is 6120 cm³ of purified water per hour. The pure water generation of the volume of 12000 cm³ of contaminated water will require about 2 hours of operation. This amount of water can be contained in an area of the chamber (2) of 25 cm×20 cm and 24 cm depth. A height of 30 cm for the dividing wall (13) facilitates a safety margin against spillovers of contaminated water into the purified water chamber. A chamber height of 40 cm provides the air space of 20 cm×10 cm for the air duct (5) between the chambers. Both chambers are of equal dimensions. The size of the entire purification device is about 50×20×40 cm³; which, is about the size of a small suitcase.

Small quantities of water for survival can be extracted from the ambient humidity by solely using a solar powered Peltier module. The humidity condensation on the cold plate of the Peltier module can be licked off.

As there are many other embodiments of this invention, it should not be limited to the embodiments disclosed, but should include all purification processes of a contaminated liquid subject to the following claims.

What is claimed is:

1. The purification process of a contaminated liquid by distillation in which the temperature difference between the contaminated liquid and the distilled purified liquid is generated by a Peltier heat pump inserted between the condensed purified liquid and the contaminated liquid.

2. The purification process of claim 1 in which said Peltier heat pump is powered by a solar panel.

3. The purification process of claim 1 with the air space between said contaminated liquid and said distilled purified liquid partially evacuated.

4. The purification process of a contaminated liquid by distillation in which the temperature difference between the contaminated liquid and the distilled purified liquid is generated by a Peltier heat pump inserted between the condensed purified liquid and the contaminated liquid; where the air space between said contaminated liquid and said distilled purifies liquid is evacuated by the use of a manually operated vacuum pump, which creates a vacuum in a cylinder by moving a piston in said cylinder, sucking in air from the chamber to be evacuated into said vacuum and then expelling said sucked-in air from said cylinder into the ambient by reversing the motion of said piston.

5. The mechanism in which the air is evacuated to create the vacuum in claim 4 is provided by an inverted bicycle pump.

6. A manually operated vacuum pump, which creates a vacuum in a cylinder by moving a piston in said cylinder, then sucking in air from the chamber to be evacuated into said vacuum and then expelling said sucked-in air from said cylinder into the ambient by reversing the motion of said piston.

7. The condensation of water from the ambient humidity by means of a Peltier module powered by a solar cell for consumption as potable water.
